(19) United States
(12) Patent Application Publication
(10) Pub. No.: US 2025/0315040 A1
(43) Pub. Date: Oct. 9, 2025

(54) UNMANNED AERIAL VEHICLE, UNMANNED AERIAL VEHICLE CONTROL SYSTEM, AND UNMANNED AERIAL VEHICLE MANAGEMENT DEVICE

(71) Applicant: Kubota Corporation, Osaka (JP)

(72) Inventor: Kohei SEINO, Sakai-shi (JP)

(21) Appl. No.: 19/246,742

(22) Filed: Jun. 24, 2025

Related U.S. Application Data
(63) Continuation of application No. PCT/JP2022/048155, filed on Dec. 27, 2022.

(51) Int. Cl. G05D 1/221; B64U 10/14; B64U 101/40; G05D 107/20

(52) U.S. Cl. CPC G05D 1/221; B64U 10/14; B64U 2101/40; B64U 2201/20; G05D 2107/21

(57) ABSTRACT

A control system includes a communication device to communicate with a management device to manage agricultural work performed by an unmanned aerial vehicle, and a controller configured or programmed to control operation of the unmanned aerial vehicle. The controller is configured or programmed or programmed to request permission from the management device, via the communication device, to activate functions associated with planned agricultural work before flight begins, and activate the functions when permitted by the management device.

### CROSS REFERENCE TO RELATED APPLICATIONS

This application claims the benefit of priority to Continuation Application of PCT Application No. PCT/JP2022/048155 filed on Dec. 27, 2022. The entire contents of this application are hereby incorporated herein by reference.

### BACKGROUND OF THE INVENTION

### 1. Field of the Invention

The present disclosure relates to unmanned aerial vehicles, control systems for unmanned aerial vehicles, and management devices for unmanned aerial vehicles.

### 2. Description of the Related Art

An unmanned aerial vehicle (UAV) is an aircraft that structurally cannot accommodate human occupants and is capable of flight through remote control or autonomous operation. A rotary-wing type unmanned aerial vehicle is a UAV that generates lift using propellers, namely rotary wings, which rotate around an axis. A small unmanned aerial vehicle including multiple rotary wings (Multi-Rotor UAV) is also called a “drone”, “multirotor”, or “multicopter”, and is widely used for applications including aerial photography, surveying, logistics, and agricultural spraying.

Japanese Patent Application Publication No. 2022-104737 describes an unmanned aerial vehicle (unmanned flying body) that changes its flight position in coordination with the operation of an agricultural machine.

### SUMMARY OF THE INVENTION

Example embodiments of the present disclosure provide technologies to reduce the risk of unauthorized use of agricultural unmanned aerial vehicles.

In a non-limiting example embodiment of the present disclosure, a control system for an unmanned aerial vehicle includes a communication device configured or programmed to communicate with a management device to manage agricultural work performed by the unmanned aerial vehicle, and a controller configured or programmed to control operation of the unmanned aerial vehicle. The controller is configured or programmed, prior to start of flight, to request permission from the management device, via the communication device, to activate functions associated with planned agricultural work, and activate the functions when permitted by the management device.

In a non-limiting example embodiment of the present disclosure, a management device for an unmanned aerial vehicle includes a communication device configured or programmed to communicate with the unmanned aerial vehicle, a storage device to store work plans for the unmanned aerial vehicle, and a processor configured or programmed to, when the communication device receives a request from the unmanned aerial vehicle for permission to activate functions associated with planned agricultural work, determine whether to permit activation based on the request and the work plans, and to send a signal indicating permission or denial to the unmanned aerial vehicle via the communication device.

According to example embodiments of the present disclosure, the risk of unauthorized use of agricultural unmanned aerial vehicles is reduced or prevented.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1A is a block diagram schematically showing several examples of rotation drivers to rotating rotors in an unmanned aerial vehicle including a plurality of rotors.

FIG. 1B is a plan view schematically showing one example of a basic configuration of an unmanned aerial vehicle including a plurality of rotors.

FIG. 1C is a side view schematically showing one example of a basic configuration of an unmanned aerial vehicle including a plurality of rotors.

FIG. 1D is a plan view schematically showing another example of a basic configuration of an unmanned aerial vehicle including a plurality of rotors.

FIG. 2A is a block diagram showing a basic configuration example of a battery-driven multicopter.

FIG. 2B is a block diagram showing a basic configuration example of a series hybrid drive type multicopter.

FIG. 2C is a block diagram showing a basic configuration example of a parallel hybrid drive type multicopter.

FIG. 3 is a diagram showing an example of a system configuration including a multicopter.

FIG. 4A is a diagram showing an example of processing performed between a multicopter and a management device.

FIG. 4B is a diagram showing another example of processing performed between a multicopter and a management device.

FIG. 5 is a flowchart showing an example of processing executed by a controller.

FIG. 6 is a flowchart showing an example of processing executed by a processor of the management device.

FIG. 7 is a diagram showing an example of a work plan.

FIG. 8 is a diagram schematically showing an example of an environment in which a multicopter flies.

FIG. 9 is a diagram schematically showing a multicopter flying while performing agricultural work within a work area.

FIG. 10 is a diagram showing an example where activation is not permitted.

FIG. 11 is a block diagram showing an example of the hardware configuration of a controller.

### DETAILED DESCRIPTION OF THE EXAMPLE EMBODIMENTS

Unmanned aerial vehicles each include a plurality of rotors and a rotation driver to rotate the rotors (hereinafter referred to as “propellers”). Hereinafter, such an unmanned aerial vehicle is referred to as a “multicopter”.

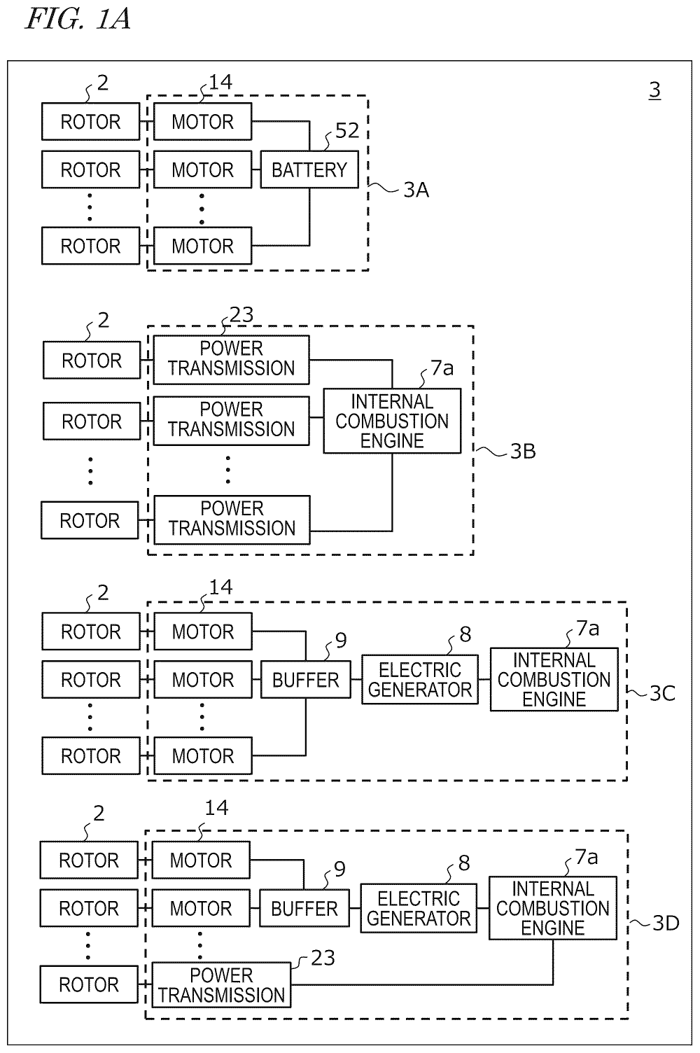

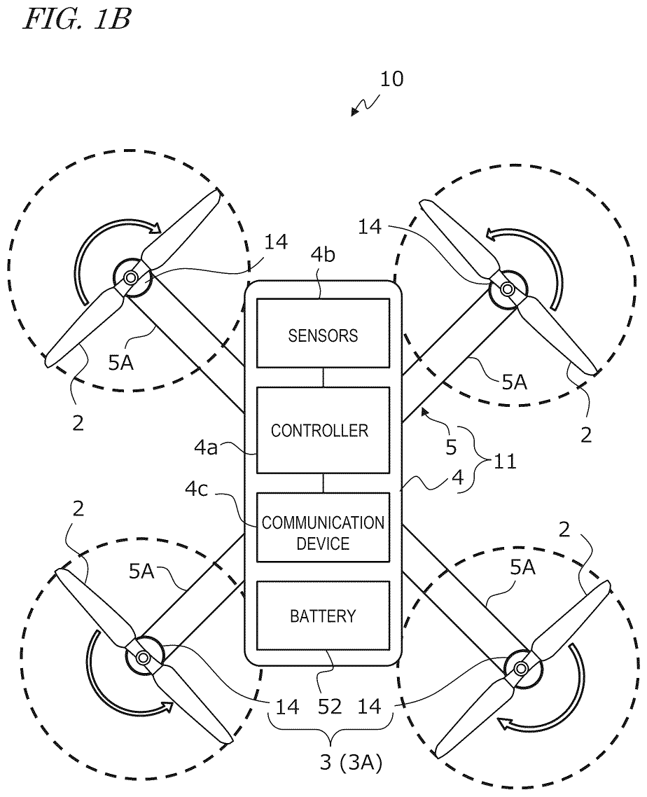

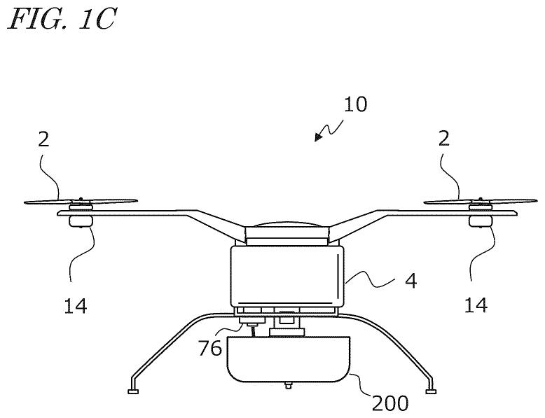

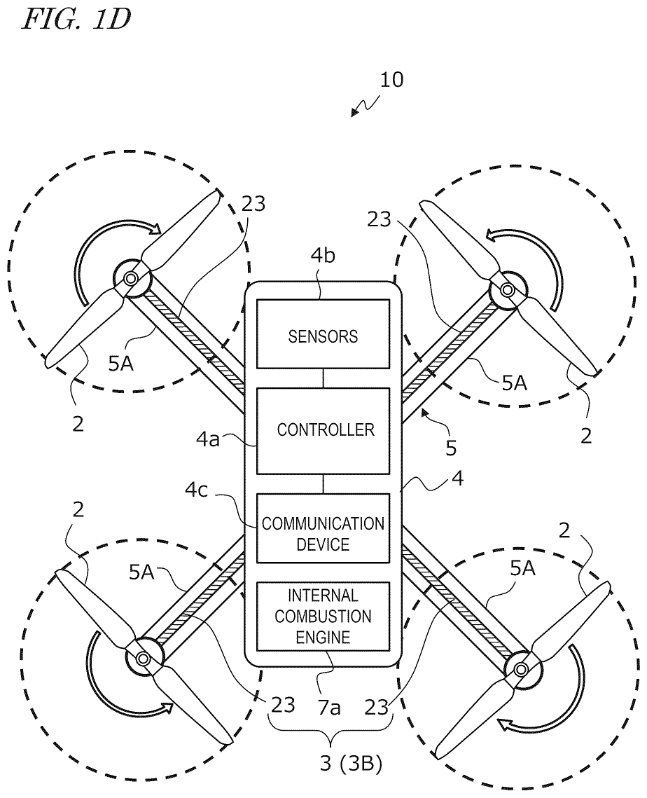

The configuration of rotation drivers included in multicopters exists in various forms. FIG. 1A is a schematic block diagram showing four examples of rotation driver 3 according to example embodiments of the present disclosure.

The first rotation driver 3A shown in FIG. 1A includes a plurality of electric motors (hereinafter referred to as “motors”) 14 that rotate a plurality of rotors 2, and a battery 52 that stores electric power to be supplied to each motor 14. The battery 52 is, for example, a secondary battery such as a polymer-type lithium-ion battery. Each rotor 2 is connected to the output shaft of its corresponding motor 14 and is rotated by the motor 14. To increase payload and/or flight duration, it is necessary to increase the power storage capacity of battery 52. While the power storage capacity of battery 52 can be increased by making battery 52 larger, enlarging battery 52 leads to an increase in weight.

The second rotation driver 3B shown in FIG. 1A includes a power transmission system 23 mechanically connected to rotor 2, and an internal combustion engine 7a that provides a driving force (torque) to power transmission system 23. The power transmission system 23 includes mechanical components such as gears or belts and transmits torque from the output shaft of internal combustion engine 7a to rotor 2. The internal combustion engine 7a can efficiently generate mechanical energy through fuel combustion. Examples of internal combustion engine 7a may include gasoline engines, diesel engines, and hydrogen engines. Additionally, the number of internal combustion engines 7a included in rotation driver 3B is not limited to one.

The third rotation driver 3C shown in FIG. 1A includes a plurality of motors 14, a power buffer 9 that stores electric power to be supplied to each motor 14, an electric generator 8 such as an alternator that generates electric power, and an internal combustion engine 7a that provides mechanical energy for power generation to the electric generator 8. While a typical example of power buffer 9 is a battery such as a secondary battery, it may also be a capacitor. In the third rotation driver 3C, even when the power buffer 9 does not have a large power storage capacity, it is possible to increase payload and/or flight duration because the electric generator 8 generates electric power using the driving force (mechanical energy) of internal combustion engine 7a. This type of driver is called a “series hybrid driver”. The electric generator 8 and internal combustion engine 7a in a series hybrid driver are called a “range extender” as they extend the flight distance of the multicopter.

The fourth rotation driver 3D shown in FIG. 1A includes a plurality of motors 14, a power buffer 9 that stores electric power to be supplied to each motor 14, an electric generator 8 such as an alternator that generates electric power, an internal combustion engine 7a that provides a driving force to the electric generator 8 for power generation, a power transmission system 23 that transmits driving force generated by the internal combustion engine 7a to the rotor 2 to rotate the rotor 2. At least one rotor 2 of the plurality of rotors 2 is rotated by the internal combustion engine 7a, while other rotors 2 are rotated by the motor 14. In the fourth rotation driver 3D, since mechanical energy generated by internal combustion engine 7a can be utilized for rotor rotation without conversion to electrical energy, energy utilization efficiency can be enhanced. This type of driver is called a “parallel hybrid driver”.

FIG. 1B is a plan view schematically showing a basic configuration example of multicopter 10. In the configuration example of FIG. 1B, a rotation driver 3 includes the first rotation driver 3A shown in FIG. 1A. That is, in this example, rotation driver 3 (3A) includes motors 14 and a battery 52. FIG. 1C is a side view schematically showing the multicopter 10.

A multicopter 10 shown in FIGS. 1B and 1C includes a plurality of rotors 2, a main body 4, and a body frame 5 that supports rotors 2 and main body 4. The body frame 5 supports the main body 4 at its central portion and supports the plurality of rotors 2 rotatably at the plurality of arms 5A extending outward from the central portion. The motors 14 that rotate rotors 2 are provided near the ends of each arm 5A. The main body 4 and body frame 5 may be collectively referred to as “body 11”.

In the example of FIG. 1B, the multicopter 10 is a quad-type multicopter (quadcopter) including four rotors 2, for example. The rotors 2 positioned on the same diagonal line rotate in the same direction (clockwise or counterclockwise), while rotors 2 positioned on different diagonal lines rotate in opposite directions.

The main body 4 includes a controller 4a configured or programmed to control the operation of devices and components mounted on multicopter 10, sensors 4b connected to the controller 4a, a communication device 4c connected to the controller 4a, and a battery 52.

The controller 4a may be configured or programmed to include, for example, a flight controller such as a flight controller and a higher-level computer (companion computer). The companion computer may perform advanced computational processing such as image processing, obstacle detection, and obstacle avoidance based on sensor data acquired by the sensors 4b.

The sensors 4b may include an acceleration sensor, angular velocity sensor, geomagnetic sensor, atmospheric pressure sensor, altitude sensor, temperature sensor, flow sensor, imaging device, laser sensor, ultrasonic sensor, obstacle contact sensor, and GNSS (Global Navigation Satellite System) receiver. The acceleration sensor and angular velocity sensor may be mounted on the main body 4 as components of an IMU (Inertial Measurement Unit). Examples of laser sensors may include a laser range finder used to measure distance to the ground, and 2D or 3D LiDAR (light detection and ranging).

The communication device 4c may include a wireless communication module for signal transmission and reception with a ground-based transmitter or ground control station (GCS) via an antenna, and a mobile communication module that utilizes cellular communication networks. The communication device 4c is configured or programmed to receive signals such as control commands transmitted from the ground and transmit sensor data such as image data acquired by sensors 4b as telemetry information. The communication device 4c may also include functions for communication between multicopters and satellite communication capabilities. The controller 4a may connect to computers in the cloud through the communication device 4c. The computer in the cloud may execute some or all of the functions of the companion computer.

A battery 52 is a secondary battery that is configured to store electric power through charging and supply electric power to motors 14 through discharging. Through the operation of battery 52 and the plurality of motors 14, a plurality of rotors 2 can be rotationally driven to generate desired thrust.

Each of the plurality of rotors 2 generally includes a plurality of blades with fixed pitch angles and generates thrust through rotation. The pitch angles may be variable. Not all of the plurality of rotors 2 need to have the same diameter (propeller diameter), and one or more rotors 2 may have a larger diameter than other rotors 2. The thrust (static thrust) generated by rotating the rotor 2 is generally proportional to the cube of the rotor's diameter. Therefore, when the rotors 2 of different diameters are included, the rotors 2 with relatively large diameters may be called “main rotors” and the rotors 2 with relatively small diameters may be called “sub-rotors”. Regardless of the size of the diameter, the rotors 2 capable of generating relatively large thrust and the rotors 2 capable of generating relatively small thrust may be included depending on the configuration of rotation driver 3. In such case, the rotors 2 capable of generating relatively large thrust may be called “main rotors” and the rotors 2 capable of generating relatively small thrust may be called “sub-rotors”. For example, the rotors 2 that generate relatively large thrust per rotation may be called “main rotors” and the rotors 2 that generate relatively small thrust per rotation may be called “sub-rotors”. In one example, main rotors may be positioned further inward than sub-rotors. In other words, the rotors 2 may be positioned such that the distance from the center of the body to the rotation axis of each main rotor is shorter than the distance from the center to the rotation axis of each sub-rotor.

In this example, the rotation driver 3 includes a plurality of motors 14. As mentioned above, the rotation driver 3 may include the internal combustion engine 7a.

FIG. 1D is a plan view schematically showing a basic configuration example of a multicopter 10 including the second rotation driver 3B. In the example shown in FIG. 1D, the internal combustion engine 7a is supported by the main body 4. In this example, the driving force generated by internal combustion engine 7a is transmitted to the plurality of rotors 2 through a plurality of power transmission systems 23 to rotate each rotor 2. The controller 4a may change the rotational speed of individual rotors 2 by controlling each power transmission system 23. Rotation driver 3B may include a mechanism to change the pitch angle of blades of each of the plurality of rotors 2. In that case, the controller 4a may adjust the lift generated by each rotor 2 by controlling that mechanism to change the blade pitch angles.

In a “parallel hybrid driver” where some of the plurality of rotors 2 are rotated by the internal combustion engine 7a and other rotors 2 are rotated by the motors 14, the internal combustion engine 7a and battery 52 are supported by the main body 4. At least one of the plurality of rotors 2 is connected to the internal combustion engine 7a through the power transmission system 23, and other rotors 2 are connected to the motors 14.

In such a parallel hybrid driver, the diameter of one or more rotors 2 rotated by the internal combustion engine 7a may be larger than the diameter of other rotors 2 rotated by the motors 14. In other words, the internal combustion engine 7a may be used to rotate the main rotors and the motors 14 may be used to rotate the sub-rotors. In such case, the main rotors are mainly used to generate thrust, and the sub-rotors are used for both generating thrust and attitude control. The main rotors may be called “booster rotors” and the sub-rotors may be called “attitude control rotors”.

In the parallel hybrid driver, the internal combustion engine is used for both thrust generation and power generation. By selectively transmitting driving force (torque) generated by the internal combustion engine to either or both of the rotor and electric generator, it is possible to achieve balanced thrust generation and power generation.

When a multicopter includes an internal combustion engine and uses the internal combustion engine for at least one of thrust generation and power generation, this contributes to increased payload and flight duration. It is desirable to perform attitude control of the multicopter by rotating propellers using motors, which have superior response characteristics compared to internal combustion engines. Therefore, in applications where accurate attitude control of the multicopter is required, it is desirable to adopt parallel hybrid drive or series hybrid drive to increase payload and flight duration. Note that when the rotation driver 3 includes a mechanism to change the pitch angle of blades of each of the plurality of the rotors 2, the attitude can also be adjusted by changing the pitch angle of each blade.

Through increased payload and flight duration, the applications of multicopters can be further expanded. For example, in the agricultural field, multicopters are currently being used for agricultural chemical spraying or crop growth monitoring. Various agricultural work can be performed from the air by connecting various ground work machines (hereinafter may be simply referred to as “work machines”) to the multicopter. Agricultural work machines are sometimes referred to as “implements”. Examples of implements may include sprayers for spraying chemicals on crops, mowers, seeders, spreaders (fertilizer applicators), rakes, balers, harvesters, plows, harrows, or rotary tillers. Work vehicles such as tractors are not included in “implements” in this disclosure.

In the example shown in FIG. 1C, an implement 200 capable of dispersing substances such as agricultural chemicals or fertilizers onto a field or crops in the field is connected to multicopter 10. Increased payload and flight duration enable the implement 200 to achieve a larger size and/or multi-functionality. For example, by changing the implement 200 connected to multicopter 10, various ground operations (agricultural work) including liquid application, granular application, fertilization, thinning, weeding, transplanting, direct seeding, and harvesting can be performed. The implement 200 may include mechanisms such as robotic hands. In that case, a single implement 200 can perform various ground operations. When the implement 200 includes space large enough to store materials, the implement 200 can also transport agricultural materials or harvested crops over a wide area. There are various forms of connecting the implement 200 to the multicopter 10. The multicopter 10 may suspend and tow the implement 200 using a cable. The implement 200 towed by the multicopter 10 can perform ground operations while being towed during flight or hovering of multicopter 10. The implement 200 during operation may be in the air or on the ground.

In the example shown in FIG. 1C, the multicopter 10 includes power supply 76. The power supply 76 is a device that supplies power to the implement 200 from driving energy sources such as a battery 52 or an electric generator 8 included in the multicopter 10. Various functions of the implement 200 may be performed using this power. The implement 200 includes actuators such as motors that operate using power obtained from the power supply 76 of the multicopter 10. The implement 200 preferably includes a battery to store power.

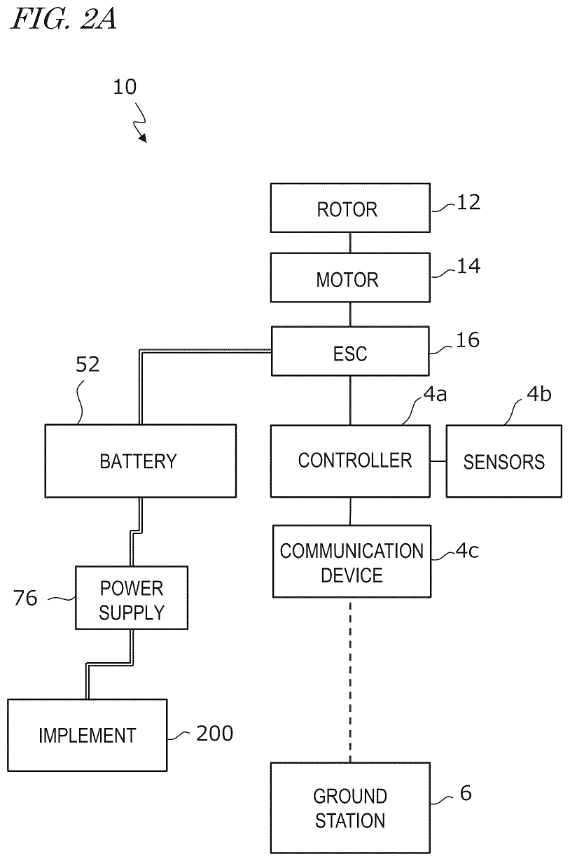

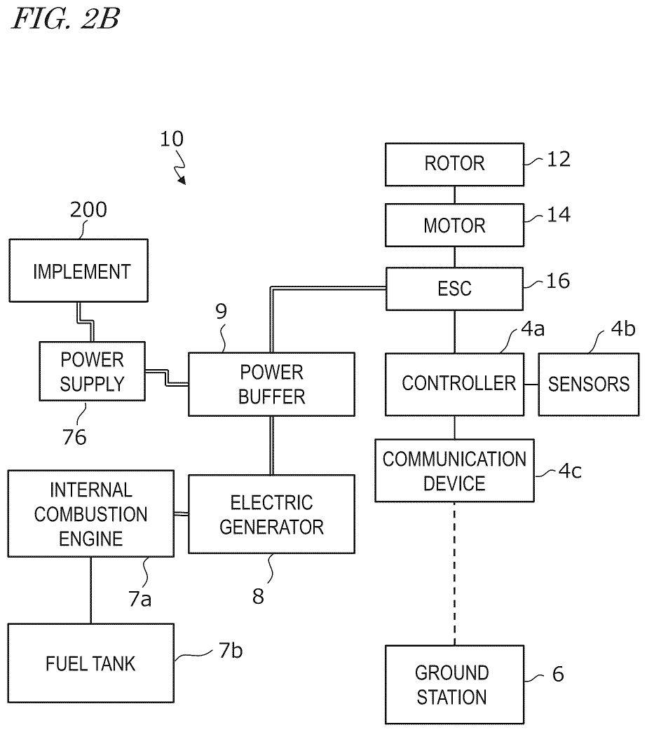

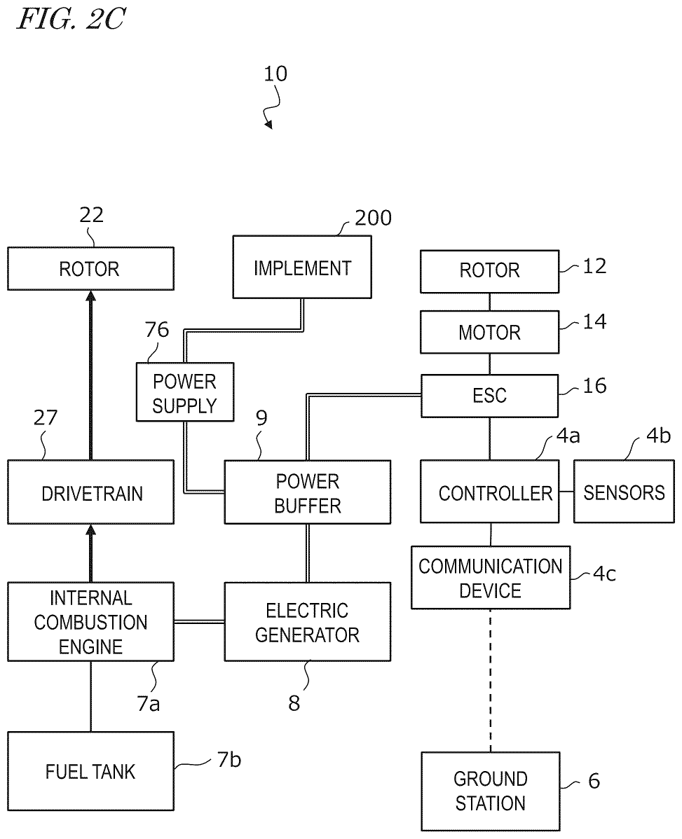

FIG. 2A shows a block diagram of a basic configuration example of a battery-driven multicopter 10. The battery-driven multicopter 10 includes a plurality of rotors 12, a plurality of motors 14, each driving a respective one of the plurality of rotors 12, a plurality of ESCs (Electric Speed Controllers) 16 each including a motor drive circuit that drives a respective one of the plurality of motors 14, a battery 52 that supplies power to each of the plurality of motors 14 through each respective ESC 16, a controller 4a configured or programmed to control a plurality of ESCs 16 to control attitude while flying, sensors 4b, a communication device 4c, and a power supply 76 that is electrically connected to the battery 52. In FIG. 2A, for simplicity, the rotor 12, the motor 14, and the ESC 16 are each shown by a single block, but the numbers of rotors 12, motors 14, and ESCs 16 are each plural. This also applies to FIGS. 2B and 2C. The ESC 16 may be included in the controller 4a.

The controller 4a may receive control commands wirelessly from, for example, a ground station 6 on the ground through the communication device 4c. The number of ground stations 6 is not limited to one, and the grand station 6 may be distributed across a plurality of locations. The communication device 4c may also wirelessly receive control commands from an operator's remote controller on the ground. The controller 4a may be configured or programmed to perform functions to automatically or autonomously execute takeoff, flight, obstacle avoidance, and landing operations based on sensor data obtained from the sensors 4b. The controller 4a may be configured or programmed to communicate with the implement 200 connected to the power supply 76 and obtain signals indicating the state of the implement 200 from the implement 200. Additionally, the controller 4a may provide signals to control the operation of the implement 200. Furthermore, the implement 200 may generate signals to instruct the operation of multicopter 10 and transmit them to the controller 4a. Such communication between the controller 4a and the implement 200 may be conducted through wired or wireless devices or methods.

FIG. 2B is a block diagram showing a basic configuration example of a series hybrid drive type multicopter 10. Like the battery-driven multicopter 10, the series hybrid drive type multicopter 10 includes a plurality of rotors 12, a plurality of motors 14, a plurality of ESCs 16, a controller 4a, sensors 4b, and a communication device 4c. The series hybrid drive type multicopter 10 shown in the figure further includes an internal combustion engine 7a, a fuel tank 7b that stores fuel for the internal combustion engine 7a, an electric generator 8 that is driven by the internal combustion engine 7a to generate electric power, a power buffer 9 that temporarily stores electric power generated by the electric generator 8, and a power supply 76 that is electrically connected to the power buffer 9. The power buffer 9 is, for example, a battery such as a secondary battery. Electric power generated by the electric generator 8 is supplied to the motors 14 through the power buffer 9 and the ESCs 16. Additionally, the electric power generated by the electric generator 8 may be supplied to the implement 200 through the power supply 76.

FIG. 2C is a block diagram showing a basic configuration example of a parallel hybrid drive type multicopter 10. Like the series hybrid drive type multicopter 10, the parallel hybrid drive type multicopter 10 includes a plurality of rotors 12, a plurality of motors 14, each driving a respective one of the plurality of rotors 12, a plurality of ESCs 16, a controller 4a, sensors 4b, a communication device 4c, an internal combustion engine 7a, a fuel tank 7b, an electric generator 8, a power buffer 9, and a power supply 76. The parallel hybrid drive type multicopter 10 further includes a drivetrain 27 that transmits driving force from the internal combustion engine 7a, and the rotor 22 that rotates upon the receiving driving force from the internal combustion engine 7a through the drivetrain 27. The rotor 12 and rotor 22 may be distinguished by calling one “first rotor” and the other “second rotor”. The number of rotors 22 connected to drivetrain 27 and rotated may be one or two or more.

In the parallel hybrid drive type multicopter 10, the internal combustion engine 7a not only drives the electric generator 8 to generate power, but also mechanically transmits energy to the rotor 22 to rotate the rotor 22. In contrast, in the series hybrid drive type multicopter 10, all rotors 12 are rotated by electric power generated by the electric generator 8. Therefore, in the series hybrid drive type multicopter 10, when the electric generator 8 is, for example, a fuel cell, the internal combustion engine 7a is not an essential component.

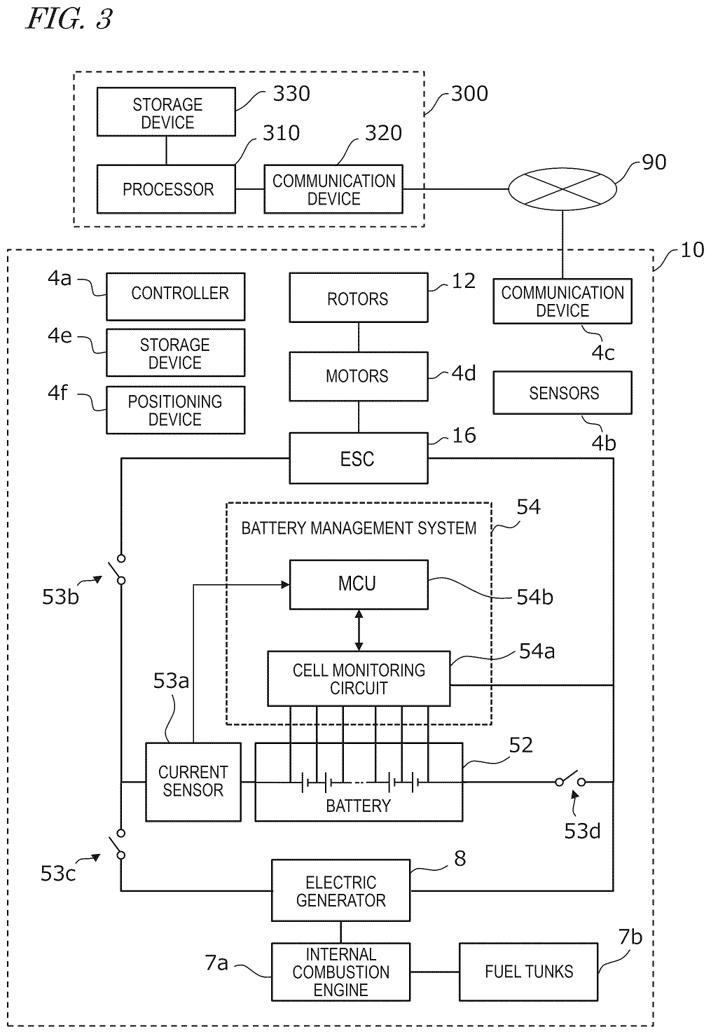

FIG. 3 shows a configuration example of a system including multicopter 10. The system shown in FIG. 3 includes multicopter 10 and a management device 300 that manages agricultural work performed by the multicopter 10. The management device 300 is a computer (such as a server in the cloud) connected to multicopter 10 via network 90. The management device 300 may be a computer system including multiple computers. The management device 300 includes a processor 310, a communication device 320, and a storage device 330.

In the example of FIG. 3, the multicopter 10 includes, generally, a plurality of rotors 12 (first rotors), a plurality of motors 14 that respectively drive the plurality of rotors 12, a battery 52 that stores power, a controller 4a configured or programmed to control the flight of the multicopter 10, sensors 4b, a communication device 4c, a storage device 4e, and a positioning device 4f. In FIG. 3, for simplicity, rotors 12, motors 14, and ESCs 16 are each shown by a single block, but the numbers of rotors 12, motors 14, and ESCs 16 are plural. Also, although not shown in FIG. 3, the multicopter 10 may include at least one second rotor 22 driven by internal combustion engine 7a as shown in FIG. 2C. In that case, either “series hybrid” or “parallel hybrid” drive format may be adopted. The multicopter 10 may not include an electric generator 8, an internal combustion engine 7a, and a fuel tank 7b. The multicopter 10 may include a mechanism to charge battery 52 by wire or wirelessly from an external power supply device.

The multicopter 10 includes a control system configured or programmed to control the operation of the multicopter 10. The control system includes a controller 4a, a communication device 4c, and a storage device 4e. The communication device 4c is an interface for communication with external devices. The communication device 4c can perform wired and wireless communication complying with various protocols. The communication device 4c may perform wireless communication complying with Bluetooth® standards and/or Wi-Fi® standards. Both standards include wireless communication standards utilizing the 2.4 GHz frequency band. The communication device 4c communicates with the communication device 320 in the management device 300. This communication may be performed via a relay device installed at a data transfer point set up around the work area in the field. Communication between the communication device 4c and the relay device is performed wirelessly. The communication device 4c transmits various information such as the position information of the multicopter 10 output from the positioning device 4f and requests for permission to activate various functions of the multicopter 10, as described later, to the communication device 320 of the management device 300. The processor 310 of the management device 300 can determine whether the position of the multicopter 10 is appropriate or whether the flight is proceeding according to plan, or can grant permission to activate the requested functions based on that information. Note that the term “activation” in this disclosure refers to a process of removing functional restrictions performed at predetermined timing such as at startup or flight initiation. The activation in this disclosure is not necessarily performed for all functions of the multicopter 10 at once, but may be performed individually for each function.

The storage device 4e may be, for example, a semiconductor memory, magnetic storage device, or optical storage device, or a combination thereof. The storage device 4e is an independent device from the controller 4a in the example of FIG. 3, but it may be included in the controller 4a. The storage device 4e stores various information related to the operation of the multicopter 10. For example, the storage device 4e can store map data useful for autonomous flight of the multicopter 10, and various sensor data acquired by the multicopter 10 during flight from the sensors 4b.

The positioning device 4f is a device that performs positioning of the multicopter 10. The positioning device 4f includes, for example, a processing circuit that calculates the position of the multicopter 10 based on satellite signals received by a GNSS receiver included in the sensors 4b. GNSS is a collective term for satellite positioning systems such as GPS (Global Positioning System), QZSS (Quasi-Zenith Satellite System, for example, Michibiki), GLONASS, Galileo, and BeiDou. The positioning device 4f may include a GNSS receiver. Additionally, the positioning device 4f may also use signals from an IMU included in the sensors 4b in addition to signals from the GNSS receiver to determine the position of the multicopter 10.

The positioning device 4f may include an RTK receiver. In that case, correction signals transmitted from a base station are used in addition to GNSS signals transmitted from multiple GNSS satellites. The base station may be installed around the field where the multicopter 10 flies (for example, within 10 km of the multicopter 10). The base station generates correction signals based on GNSS signals received from multiple GNSS satellites and transmits them to the positioning device 4f. The positioning device 4f performs positioning by calculating the position of the multicopter 10 based on GNSS signals and correction signals. By using RTK-GNSS, it is possible to perform positioning with an accuracy of, for example, a few centimeters of error. Position information including latitude, longitude, and altitude is obtained through high-precision positioning by RTK-GNSS. Note that the positioning method is not limited to RTK-GNSS, and any positioning method that provides position information with the required accuracy (such as interferometric positioning method or relative positioning method) can be used. For example, positioning using VRS (Virtual Reference Station) or DGPS (Differential Global Positioning System) may be performed.

The multicopter 10 of this example embodiment includes a current sensor 53a that measures current flowing through the battery 52, and switch elements 53b, 53c, 53d that define the current path during discharge and charging of the battery 52. During charging, current flows from the electric generator 8 to the battery 52 through closed switch elements 53c, 53d. During discharge, current flows from the battery 52 to ESCs 16 and motors 14 through closed switch elements 53b, 53d. The multicopter 10 may further include other switch elements and/or current sensors. The opening and closing of switch elements 53b, 53c, 53d may be controlled by the controller 4a.

The multicopter 10 of this example embodiment includes a battery management system 54 that monitors and manages the battery 52. The battery management system 54 includes a cell monitoring circuit 54a that monitors the state (such as voltage and temperature) of each of a plurality of single cells (cells) included in the battery 52, and a microcontroller (Microcontroller Unit: MCU) 54b that estimates the charging state of the battery 52 and executes battery management operations.

The cell monitoring circuit 54a may be configured to measure the voltage of each cell and perform cell balancing during charging. The cell monitoring circuit 54a may include a protection circuit that prevents overcharging and over-discharging of each cell. Such protection circuits may be provided in battery packs, each including multiple cells.

The MCU 54b may be configured or programmed to perform various calculations for estimating the State Of Charge (SOC) of the battery 52. The SOC is equal to the Remaining Charge (RC) divided by the Full Charge Capacity (FCC), that is, RC/FCC. The SOC defined in this way may sometimes be called “Relative SOC (RSOC)”. The SOC can be estimated by various algorithms.

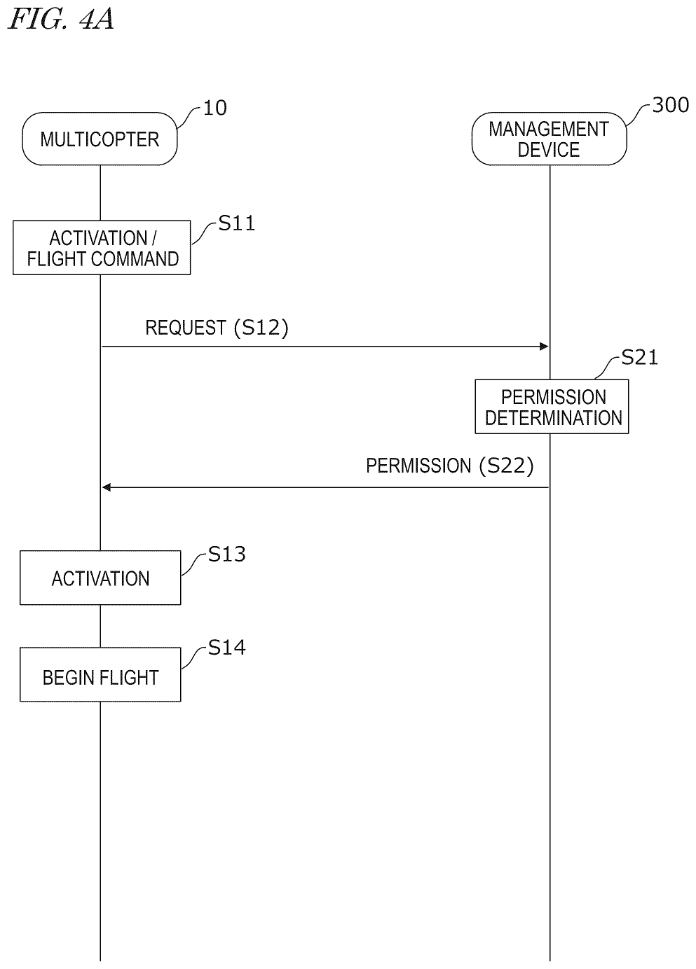

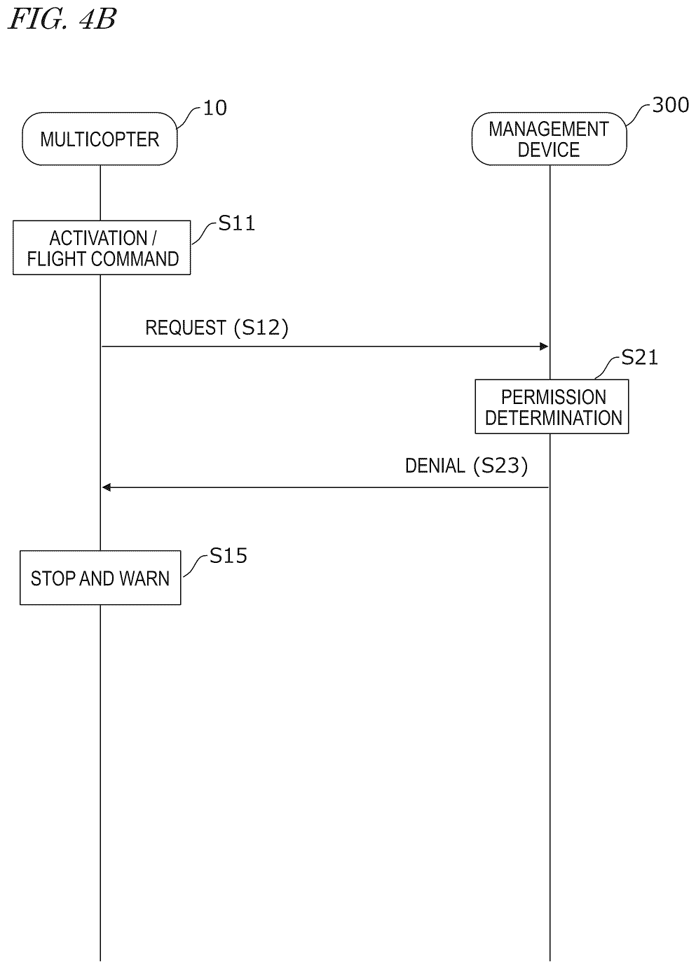

Next, examples of control methods for multicopter 10 will be explained with reference to FIGS. 4A and 4B.

FIG. 4A shows an example of processing performed between multicopter 10 and management device 300. In this example embodiment, the controller 4a requests permission from the management device 300 via the communication device 4c to activate functions associated with planned agricultural work before flight begins, and activates the functions when permitted by the management device 300. For example, the controller 4a may be configured or programmed to request permission from the management device 300 to activate functions to fly over the work area where agricultural work is planned, and to activate the functions to fly over the work area when permitted by the management device 300. When an implement 200 to perform agricultural work is connected to the multicopter 10 as shown in FIG. 1B, the controller 4a may request permission from the management device 300 for activation of the function to drive the implement 200 as a function associated with agricultural work. In that case, the controller 4a activates the function to drive the implement when permitted by the management device 300.

In the example of FIG. 4A, the controller 4a of multicopter 100 requests permission to activate functions associated with planned agricultural work from the management device 300 when the multicopter 100 is started or when it receives a flight command (Step S11).

The work plan for multicopter 10 is pre-recorded in the storage device 330 of the management device 300. The work plan is data that defines the plan for agricultural work to be performed by the multicopter 10. The work plan may include information such as the planned date and time, location, type of work, and/or type of implement to be used for each operation performed by the multicopter 10. When the communication device 320 receives a request from the multicopter 10 for permission to activate functions associated with planned agricultural work, the processor 310 of the management device 300 determines whether to permit activation based on the request and the work plan (Step S21). The processor 310 sends a signal indicating permission or denial to the multicopter 10 via the communication device 320 (Step S22). In the example of FIG. 4A, the processor 310 sends a signal indicating permission to activate to the multicopter 10.

When the communication device 4c of the multicopter 10 receives the signal indicating permission to activate, the controller 4a activates the permitted functions. After that, the controller 4a begins flight for agricultural work by automatic or manual piloting (Step S14).

FIG. 4B shows another example of processing performed between multicopter 10 and management device 300. In the example of FIG. 4B, the processor 310 of the management device 300 makes a determination of denial in response to the activation permission request from the multicopter 10. The determination of denial may be made, for example, when the multicopter 10 is located in a place different from the field where the planned agricultural work is to be performed, or when it does not have the implement that should be used attached. In the example of FIG. 4B, after the permission determination in Step S21, a signal indicating denial is sent to the multicopter 10 (Step S23). When the controller 4a of the multicopter 10 receives the denial signal, it may be configured, for example, to stop the operation of the multicopter 10 and send a warning signal to an external device. The external device may be an information terminal used by the user of the multicopter 10. The information terminal may be configured or programmed to output an image or sound indicating that the multicopter 10 is attempting to perform an unplanned operation in response to the warning signal. This allows the user to be alerted about the possibility of theft or unauthorized use. The controller 4a may also send the warning signal to the management device 300. In that case, a warning is notified to the information terminal used by the user via the management device 300.

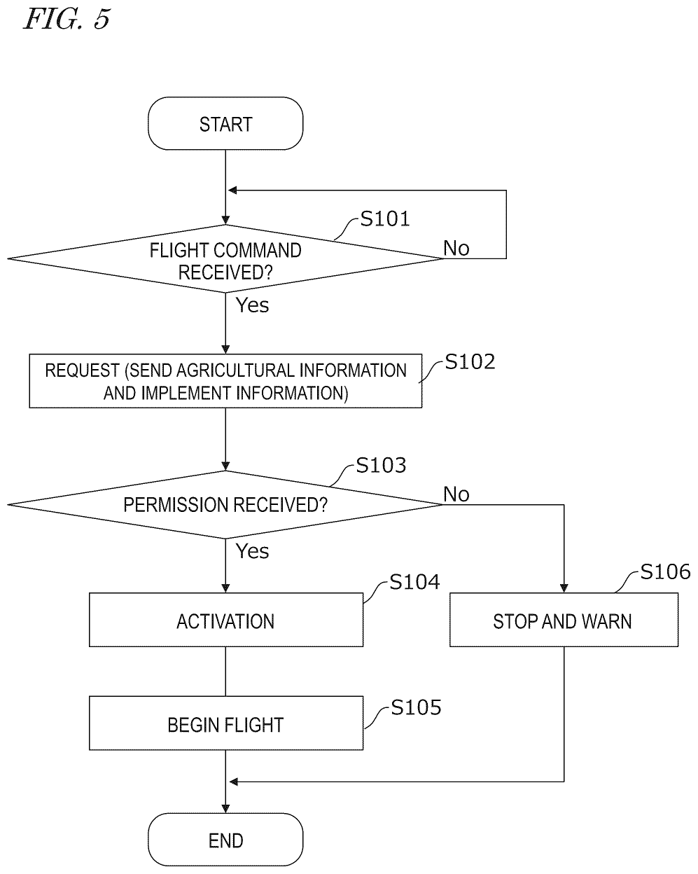

FIG. 5 is a flowchart showing an example of processing executed by the controller 4a. In the example of FIG. 5, after startup of the multicopter 10, the controller 4a determines whether a flight command has been received (Step S101). The flight command may be transmitted from a remote controller used by the user or a computer that performs remote operation of the multicopter 10. When a flight command is received, the controller 4a requests permission from the management device 300 to activate functions to start flight (Step S102). At this time, the controller 4a may also be configured or programmed to transmit information indicating the type of agricultural work to be performed (agricultural work information) and/or information indicating the type of implement connected to the multicopter 10 (implement information). In that case, the processor 310 of the management device 300 may be configured or programmed to determine whether to permit activation by comparing the transmitted agricultural work information and/or implement information with the predetermined work plan.

Additionally, when requesting permission to activate from the management device 300, the controller 4a may send route information regarding the flight path for the planned agricultural work and/or area information regarding the work area for the agricultural work via the communication device 4c to the management device 300. In that case, the management device 300 determines whether to permit activation based at least on the predetermined work plan for the multicopter 10 and the transmitted route information and/or area information. This makes it possible to avoid granting activation when the requested flight path and/or work area does not match the work plan.

The controller 4a may also send position information of the multicopter 10 output from the positioning device 4f via the communication device 4c to the management device 300 when requesting permission to activate from the management device 300. In that case, the management device 300 determines whether to permit activation based at least on the predetermined work plan for the multicopter 10 and the transmitted position information. This makes it possible to avoid granting activation when the position of the multicopter 10 is not consistent with the position of the field indicated in the work plan.

After Step S102, the controller 4a determines whether activation has been permitted (Step S103). If activation has been permitted, the controller 4a activates the permitted functions (Step S104) and begins flight (Step S105). If activation has not been permitted, the controller 4a stops the operation of the multicopter 10 and sends a warning to an external device (Step S106).

With these operations, even if the multicopter 10 is stolen, unauthorized use can be reduced or prevented.

In the example of FIG. 5, the controller 4a sends a permission request to activate functions associated with planned agricultural work to the management device 300 in response to a flight command. Alternatively, the controller 4a may send the permission request when the power of the multicopter 10 is turned on and it begins to start up. The controller 4a may make the permission request at startup every time or at a frequency of once every several times. For example, the controller 4a may count the number of startups of the multicopter 10 and request permission to activate from the management device 300 when the number of startups reaches a predetermined number. This makes it possible to prevent unauthorized use of the multicopter 10 more than the predetermined number of times if the multicopter 10 is stolen.

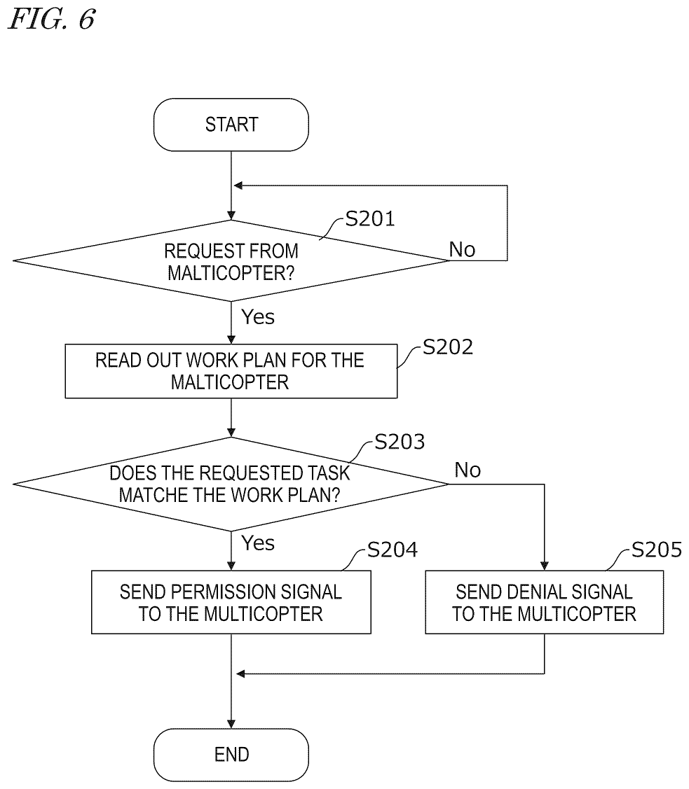

FIG. 6 is a flowchart showing an example of processing executed by the processor 310 of the management device 300. In the example of FIG. 6, the processor 310 waits for a request for permission to activate from the multicopter 10 (Step S201). Upon receiving the request, the processor 310 reads out the work plan for that multicopter 10 from the storage device 4e (Step S202). The processor 310 determines whether the work related to the request matches the work plan (Step S203). If the work related to the request matches the work plan, the processor 310 sends a permission signal to the multicopter 10 (Step S204). If the work related to the request does not match the work plan, the processor 310 sends a denial signal to the multicopter 10 (Step S205).

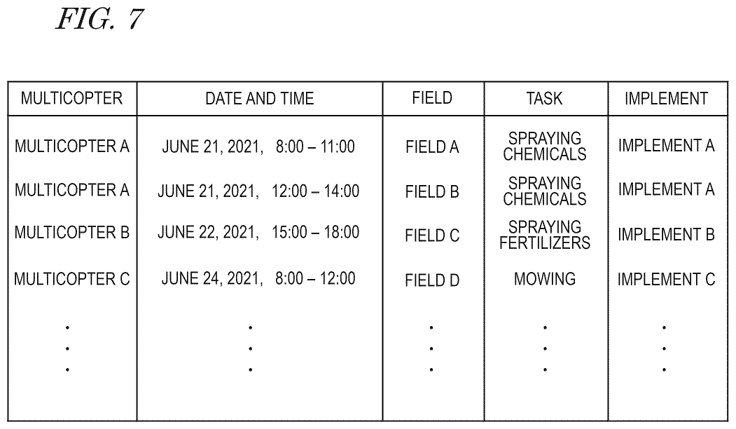

FIG. 7 shows an example of a work plan. The work plan shown in FIG. 7 includes an identifier of the multicopter 10, the planned date and time for the work, a field identifier, information indicating the work content, and information indicating the type of implement to be used. By referring to such a work plan, it is possible to appropriately determine whether to permit requests from the multicopter 10. The work plan is not limited to the information shown in FIG. 5 and may include other information (such as information on the types of chemicals or fertilizers to be used). The work plan may be created based on operations by a user using an information terminal.

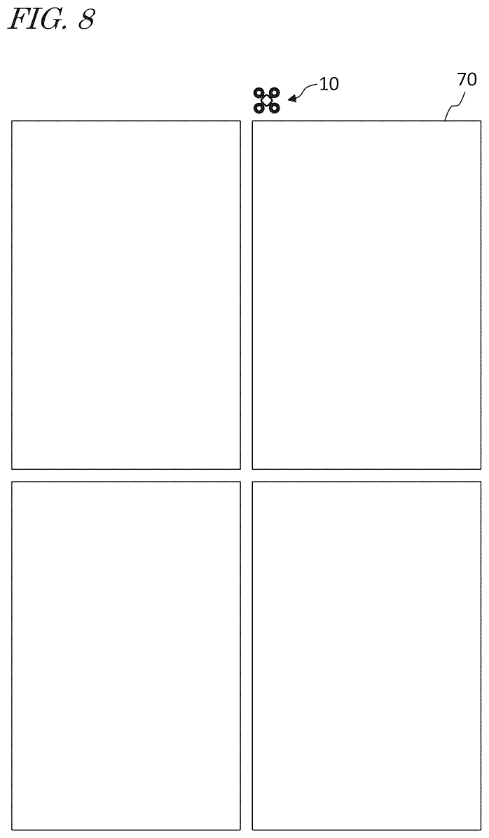

Next, the restriction of functions of the multicopter 10 in this example embodiment will be explained in more detail with reference to FIGS. 8 to 10.

FIG. 8 schematically shows an example of an environment in which the multicopter 10 flies. The multicopter 10 in this example embodiment flies while performing agricultural work over a pre-set work area 70. The work area 70 may be set within a field. The multicopter 10 can perform agricultural work such as agricultural chemical spraying while flying over the work area 70. Instead of the multicopter 10 itself performing agricultural work, an implement 200 connected to (or suspended from) the multicopter 10, as shown in the example of FIG. 1B, may perform the agricultural work. Even in such cases, in this specification, it is expressed as “the multicopter 10 executes agricultural work.” The multicopter 10 may fly over the field automatically, autonomously, or by remote control. The multicopter 10 can operate in both autonomous driving mode and manual driving mode.

In this example embodiment, as mentioned earlier, before the multicopter 10 begins to fly, it requests permission from the management device 300 to activate functions associated with planned agricultural work, and only when permitted, activates those functions. When the request is permitted, the multicopter 10 becomes capable of flying over the work area 70 within the field.

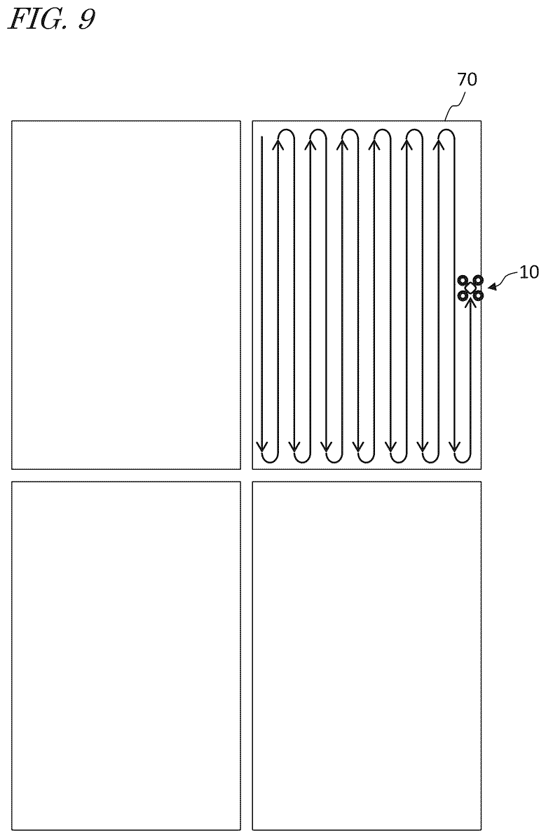

FIG. 9 schematically shows the multicopter 10 flying while performing agricultural work within the work area 70. In FIG. 9, the arrow lines shown within the work area 70 schematically indicate the flight path that the multicopter 10 has passed through by autonomous driving mode. In autonomous driving mode, the multicopter 10 is controlled to fly along a predetermined target path. In autonomous driving mode, the controller 4a makes the multicopter 10 fly along the target path based on the position of the multicopter 10 measured by the positioning device 4f and the target path set over the work area 70. The target path may be pre-set by the user, and that information is recorded in the storage device 4e. The user can set the work area 70 and the target path through operations using a GUI (Graphical User Interface) including a map of the field displayed on a setting information terminal.

When the multicopter 10 performs agricultural work in this way, it often flies along a predetermined path over the work area 70 such as a field. However, the work that an agricultural multicopter 10 can perform is not limited to such examples and may include work carried out over a wide area including multiple fields, such as replenishment and transport of agricultural materials, transport of harvested crops, monitoring of crop growth conditions, surveying, and map creation. When the multicopter 10 performs transport of agricultural materials or harvested crops, for example, the multicopter 10 may fly over areas other than fields (including areas with forests, rivers, etc.) automatically, autonomously, or by remote control.

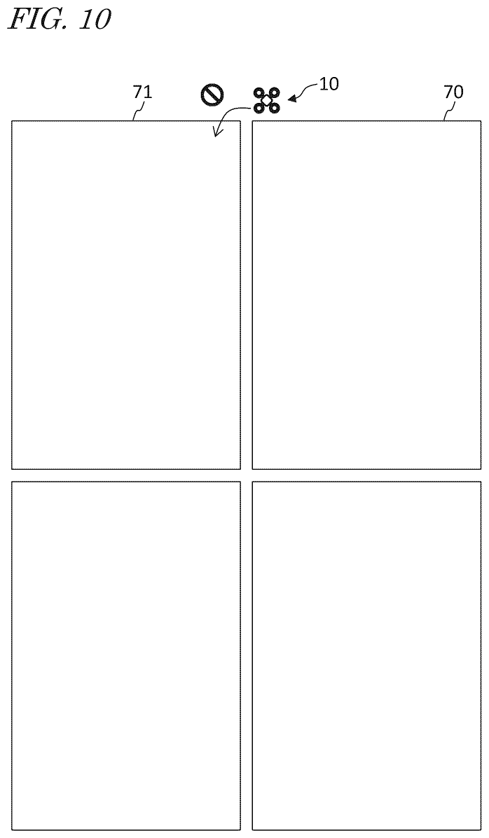

FIG. 10 shows an example where activation is not permitted. In the example of FIG. 10, the controller 4a requests permission from the management device 300 for the multicopter 10 to fly over a non-work area 71 where agricultural work is not planned at that date and time. In this case, the controller 4a sends a request including an identifier of the non-work area 71 to the management device 300. The management device 300, based on the work plan, sends a signal to the multicopter 10 indicating that the request is not permitted because no agricultural work is planned in the non-work area 71 at that date and time. Based on that signal, the controller 4a stops the operation of the multicopter 10 and outputs a warning. This avoids the multicopter 10 flying over the non-work area 71 where work is not planned.

In this way, the controller 4a activates functions such as flight of the multicopter 10 only when permitted by the management device 300. The controller 4a may also activate the remote controller for the multicopter 10 in addition to the permitted functions of the multicopter 10 when activation permission is received. This allows the remote controller to be usable only when permitted by the management device 300, thus preventing unauthorized use of the remote controller.

The controller 4a may also be configured or programmed to activate the positioning device 4f only when activation permission is received. This restricts the functions of the multicopter 10 by making the positioning device 4f unusable when activation is not permitted due to unauthorized use.

The controller 4a may count the number of times activation was not permitted, and notify the management device 300 when the count reaches a predetermined number (for example, 3, 5, 10, etc.). The count may be reset when activation is permitted. In response to the notification, the management device 300 may send a command to the multicopter 10 to move to a specified location. Alternatively, instead of the controller 4a, the management device 300 may count the number of times it denied requests from the multicopter 10, and when the count reaches a predetermined number, send a command to the multicopter 10 to move to a specified location. In that case, the controller 4a moves the multicopter 10 to the specified location in response to the command from the management device 300. The specified location may be, for example, a storage facility for the multicopter 10 specified by the user, or a specific location such as a police station. Alternatively, when the number of times activation was not permitted reaches a predetermined number, the management device 300 may send a notification indicating suspicion of unauthorized use to an information terminal used by the user of the multicopter 10. The notification may include the position of the multicopter 10 measured by the positioning device 4f of the multicopter 10. This makes it easier to find the multicopter 10 even if it has been stolen.

The controller 4a in the present example embodiment of the present disclosure may be realized by a digital computer system programmed to execute each process explained with reference to FIG. 5. Also, the processor 310 of the management device 300 may be realized by a digital computer system programmed to execute each process explained with reference to FIG. 6.

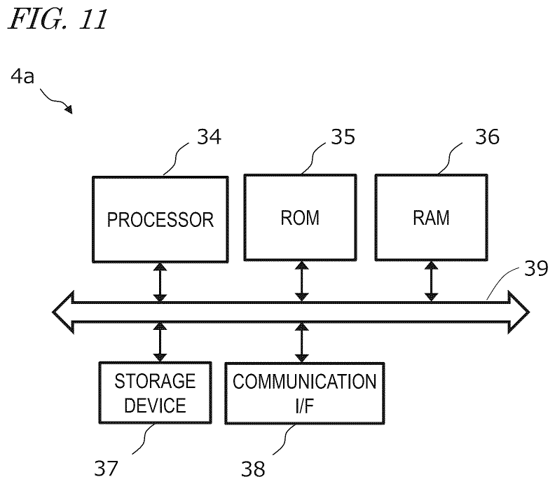

FIG. 11 is a block diagram showing an example of the hardware configuration of the controller 4a. The controller 4a includes a processor 34, ROM (Read Only Memory) 35, RAM (Random Access Memory) 36, a storage device 37, and a communication I/F 38. These components are interconnected via a bus 39. In the example of FIG. 11, the controller 4a includes the storage device 37 and the communication I/F 38. In this case, the storage device 37 and the communication I/F 38 may substitute the functions of the storage device 4e and the communication device 4c shown in FIG. 3.

The processor 34 may include one or more semiconductor integrated circuits, also referred to as a central processing unit (CPU) or microprocessor. The processor 34 sequentially executes computer programs stored in the ROM 35 to implement the aforementioned processes. The processor 34 may include terms such as FPGA (Field Programmable Gate Array) with CPU, GPU (Graphic Processor Unit), ASIC (Application Specific Integrated Circuit), or ASSP (Application Specific Standard Product).

The ROM 35 is, for example, a writable memory (such as PROM), rewritable memory (such as flash memory), or read-only memory. The ROM 35 stores programs that control the operation of the processor. The ROM 35 need not be a single recording medium but may be a collection of multiple recording media. Some of the multiple collections may be removable memory.

The RAM 36 provides a work area for temporarily expanding programs stored in the ROM 35 during boot-up. The RAM 36 need not be a single recording medium but may be a collection of multiple recording media.

The communication I/F 38 is an interface for communication between the controller 4a and other electronic components or electronic control units (ECUs). For example, the communication I/F 38 can perform wired communication complying with various protocols. The communication I/F 38 may perform wireless communication complying with Bluetooth® standards and/or Wi-Fi® standards. Both standards include wireless communication standards utilizing the 2.4 GHz frequency band.

The storage device 37 may be, for example, a semiconductor memory, magnetic storage device, or optical storage device, or a combination thereof. The storage device 37 can store, for example, map data useful for autonomous flight of the multicopter 10, and various sensor data acquired by the multicopter 10 during flight.

Note that, as mentioned earlier, the controller 4a may be configured or programmed to include, for example, a flight controller such as a flight controller and a higher-level computer (companion computer). The companion computer may execute each process shown in FIG. 8, 9, or 11 and provide flight-related commands from the companion computer to the flight controller based on the results of those processes.

The processor 310 of the management device 300 may also have a hardware configuration similar to that shown in FIG. 11.

A system providing various functions in the above example embodiment can also be installed later on multicopters that do not have those functions. Such systems may be manufactured and sold independently from multicopters. Computer programs used in such systems may also be manufactured and sold independently from multicopters. Computer programs may be provided stored on a non-transitory computer-readable storage medium, for example. Computer programs may also be provided by downloading via a telecommunications line (such as the Internet).

Unmanned aerial vehicles according to example embodiments of the present disclosure may be widely utilized not only for applications such as aerial photography, surveying, logistics, and agricultural spraying, but also for ground work related to agricultural work, and transportation of harvested crops and agricultural materials.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A control system for an agricultural unmanned aerial vehicle, comprising:
a communication device configured or programmed to communicate with a management device to manage agricultural work performed by the unmanned aerial vehicle; and
a controller configured or programmed to control operation of the unmanned aerial vehicle; wherein
the controller is configured or programmed to, prior to start of flight, request permission from the management device, via the communication device, to activate functions associated with planned agricultural work, and to activate the functions when permitted by the management device.

2. The control system according to claim 1, wherein the controller is configured or programmed to request permission from the management device to activate a function for flying over a work area where agricultural work is planned as a function associated with the agricultural work, and to activate the function for flying over the work area when permitted by the management device.

3. The control system according to claim 1, wherein
the unmanned aerial vehicle is configured or programmed to be connected to a ground work implement configured to execute the agricultural work;
the controller is configured or programmed to:
request permission from the management device to activate a function to drive the ground work implement as a function associated with the agricultural work; and
activate the function to drive the ground work implement when permitted by the management device.

4. The control system according to claim 1, wherein the controller is configured or programmed to request the permission to activate from the management device when the unmanned aerial vehicle starts up or receives a flight command.

5. The control system according to claim 1, wherein the controller is configured or programmed to count a number of startups of the unmanned aerial vehicle, and to request the permission to activate from the management device when the number of startups reaches a predetermined number.

6. The control system according to claim 1, wherein
the unmanned aerial vehicle includes a positioning device; and
the controller is configured or programmed to activate the positioning device upon receiving permission to activate.

7. The control system according to claim 1, wherein the controller is configured or programmed to activate a remote controller for the unmanned aerial vehicle upon receiving permission to activate.

8. The control system according to claim 1, wherein the controller is configured or programmed to count a number of times activation was not permitted, and to notify the management device when the count reaches a predetermined number.

9. The control system according to claim 8, wherein the controller is configured or programmed, after notifying the management device, to move the unmanned aerial vehicle to a specified location in response to a command from the management device.

10. The control system according to claim 1, wherein:
the controller is configured or programmed, when requesting permission to activate from the management device, to send work information indicating a type of the planned agricultural work to the management device via the communication device; and
the management device is configured or programmed to determine whether to permit activation based at least on a predetermined work plan for the unmanned aerial vehicle and the work information.

11. The control system according to claim 1, wherein:
the unmanned aerial vehicle is configured or programmed to be connected to a ground work implement configured to execute the agricultural work;
the controller is configured or programmed, when requesting permission to activate from the management device, to send implement information indicating a type of the ground work implement connected to the unmanned aerial vehicle to the management device via the communication device; and
the management device is configured or programmed to determine whether to permit activation based at least on a predetermined work plan for the unmanned aerial vehicle and the implement information.

12. The control system according to claim 1, wherein
the controller is configured or programmed, when requesting permission to activate from the management device, to send route information regarding a flight path for the planned agricultural work and/or area information regarding a work area for the agricultural work to the management device via the communication device; and
the management device is configured or programmed to determine whether to permit activation based at least on a predetermined work plan for the unmanned aerial vehicle and the route information and/or the area information.

13. The control system according to claim 1, wherein
the unmanned aerial vehicle includes a positioning device configured or programmed to output position information of the unmanned aerial vehicle;
the controller is configured or programmed, when requesting permission to activate from the management device, to send the position information to the management device via the communication device; and
the management device is configured or programmed to determine whether to permit activation based at least on a predetermined work plan for the unmanned aerial vehicle and the position information.

14. An unmanned aerial vehicle comprising:
the control system according to claim 1; and
a plurality of rotors controlled by the control system.

15. A management device for managing agricultural work performed by an agricultural unmanned aerial vehicle, the management device comprising:
a communication device configured or programmed to communicate with the unmanned aerial vehicle;
a storage device to store a work plan for the unmanned aerial vehicle; and
a processor configured or programmed to, when the communication device receives a request from the unmanned aerial vehicle for permission to activate functions associated with planned agricultural work, determine whether to permit activation based on the request and the work plan, and to send a signal indicating permission or denial to the unmanned aerial vehicle via the communication device.
